(19) United States
(12) Patent Application Publication
(10) Pub. No.: US 2022/0284456 A1
(43) Pub. Date: Sep. 8, 2022

(54) SYSTEM FOR FACILITATING DIRECT COMMUNICATIONS

(71) Applicant: ChaChingMe, Inc, Chicago, IL (US)

(72) Inventors: Maximillian SUGRUE, Chicago, IL (US); Gary YI, Chicago, IL (US); Noor SUGRUE, Chicago, IL (US)

(73) Assignee: ChaChingMe, Inc, Chicago, IL (US)

(21) Appl. No.: 17/689,149

(22) Filed: Mar. 8, 2022

Related U.S. Application Data
(60) Provisional application No. 63/158,109, filed on Mar. 8, 2021.
(60) Provisional application No. 63/241,416, filed on Sep. 7, 2021.
(60) Provisional application No. 63/284,353, filed on Nov. 30, 2021.
(60) Provisional application No. 63/291,255, filed on Dec. 17, 2021.

(51) Int. Cl. G06Q 30/02

(52) U.S. Cl. CPC G06Q 30/0201; G06Q 30/0276; G06Q 30/0215; G06Q 30/0277

(57) ABSTRACT

Systems and methods are provided for generating and transmitting communications between merchant, advertiser, and consumer user devices associated with a future purchase that is initially identified by the consumer user. The disclosure describes these and other perspectives of matching and limiting the advertisements and items to a time frame initiated by the consumer user.

### CROSS REFERENCE TO RELATED APPLICATIONS

This non-provisional patent application claims priority from the following applications: U.S. Patent Application No. 63/158,109, filed Mar. 8, 2021; U.S. Patent Application No. 63/241,416, filed Sep. 7, 2021; U.S. Patent Application No. 63/284,353, filed Nov. 30, 2021, and U.S. Patent Application No. 63/291,255, filed Dec. 17, 2021. The contents of all above applications are incorporated by reference in their entirety.

### TECHNICAL FIELD

The disclosed technology relates generally to providing a platform to establish connections and initiate direct communications between users. More particularly, various embodiments relate to systems and methods for applying a matching process and trained machine learning models to form communication connections between users.

### BACKGROUND

Traditional systems provide communications to consumer users in various ways. Very old systems may provide mailers or generic advertisements or coupons to users by transmitting the advertisement to the user once the consumer user signs up for a marketing campaign. The advertisements may be sent to the consumer user on a weekly or monthly basis via physical mail or electronic mail. When the consumer provides the mailer or generic advertisement to a merchant, or when they select a link in an electronic mail advertisement, the merchant might discount the price of the item based on the value presented in advertisement.

Other older communication systems may track a consumer user's online activity and attempt to predict which items the consumer user may be interested in, without requiring the consumer user to sign up for the mailing campaign. The advertising system can preemptively show an advertisement (e.g., in a social media context, etc.) that displays an item in hopes that the consumer user will visit a manufacturer or merchant (e.g., online store, physical brick and mortar store, etc.) to purchase the item associated with the advertisement. The consumer can select a link in a digital advertisement that directs the consumer user to the particular manufacturer or merchant, which can discount the price of the item based on the value presented in advertisement, introduce a new product or service offering to the consumer, or serve other marketing objectives. However, most of these advertisements are initiated by manufacturer, merchant, or advertiser users attempting to sell more of the product without consideration for what the consumer user specifically intends to purchase on a particular day, either directly to the consumer user or via another medium such as social media.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is an illustrative connection and communication platform, in accordance with the embodiments disclosed herein.

FIG. 2 is an illustrative manufacturer user device, in accordance with the embodiments disclosed herein.

FIG. 3 is an illustrative process for a manufacturer to set offers for consumers in accordance with embodiments disclosed herein.

FIG. 4 is an illustrative process for a manufacturer user device, in accordance with the embodiments disclosed herein.

FIG. 5 is an illustrative advertiser user device, in accordance with the embodiments disclosed herein.

FIG. 6 is an illustrative process for an advertiser user device, in accordance with the embodiments disclosed herein.

FIG. 7 is an illustrative consumer user device, in accordance with the embodiments disclosed herein.

FIG. 8 is an illustrative process for a consumer user device, in accordance with the embodiments disclosed herein.

FIG. 9 is an illustrative process for a manufacturer user device, in accordance with the embodiments disclosed herein.

FIG. 10 illustrates a user interface to provide instructions to consumer user device regarding a registration process, in accordance with the embodiments disclosed herein.

FIG. 11 illustrates a user interface to receive one or more advertisements associated with a list of items in a future purchase, in accordance with the embodiments disclosed herein.

FIG. 12 illustrates a user interface to accept proof of purchase of items identified in the future purchase and a user interface after proof of purchase of items identified in the future purchase have been received, in accordance with the embodiments disclosed herein.

FIG. 13 illustrates an example user interface after a consumer performs a search for a product term, in accordance with the embodiments disclosed herein.

FIG. 14 is an example of a computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Direct communication online, through social networks or other media, has become an integral part of successful business, social, and economic environments. New methods and products to assist with online communication continue to emerge and progress, resulting in a need for more intelligent processing, particularly through machine learning. Machine learning has been implemented in communication networks to generate stronger online connections by tailoring to a user's individual needs. Modern machine learning techniques provide ample opportunities to enable communication between devices that can provide as much value as in-person communication.

Machine learning also assists communication networks with autonomous decision making. This provides information to one or more users without requiring significant input. Rather, machine learning can pull from the user's active participation in online communication without the user's focus. As real-world network systems become more complex, there are many situations that require multiple applications of machine learning to facilitate intelligent decision-making, resulting in a large growth in the application of machine learning to communication networks in recent years.

Embodiments of the application identify innovative systems and methods from multiple perspectives. For example, a software application at a consumer user device or a connection and communication platform can pose one or more questions to the consumer user associated with their planned future purchases. The questions may ask the user if they intend to initiate a future purchase of an item type and what item type they plan to purchase in a time range (e.g., the next 24 hours, etc.).

Item types may cover various characteristics. For example, an item type may correspond with a generic item description, including a shirt or pants, books, kitchenware, a lawnmower, and the like. In another example, the item type may correspond with a particular item description, including a brand (e.g., Acme Co., etc.) or trademark name of an item. In another example, an item type may correspond with a general activity or event associated with using the item, including items for going on a ski trip, gardening items, back to school supplies, and the like.

Based on the item type that the consumer user identifies, the application or platform may provide a set of advertisements for items related to the item type that the consumer user plans to purchase, along with a time limit and monetary reward for completing the future purchase. The consumer user may select one or more of the advertisements and the advertisement details can be stored in association with the user at the consumer user device or connection and communication platform. In some examples, the consumer user may view each advertisement of the set of advertisements and select one or more from the set. When the future purchase is made within the time limit, the monetary reward for completing the purchase may be transmitted from a first digital wallet (e.g., advertiser, manufacturer, merchant, platform operator, etc.) to the digital wallet associated with the consumer user.

From a manufacturer user's perspective, the connection and communication platform may receive a trigger notification of a future purchase of an item type. The future purchase may be associated with a consumer user device (e.g., a client device, a consumer user, etc.). Upon receiving the trigger notification, the connection and communication platform may initiate a matching procedure that correlates the item type with an item identifier in an item database of an item manufacturer or alternative third-party data source. The connection and communication platform may determine an alert notification associated with the item identifier of the item manufacturer and enable transmission of the alert notification to the consumer user device. In some examples, the alert notification is an advertisement to reduce a cost of an item (e.g., for the consumer user) in the future purchase. As further explained below, the manufacturer may set parameters to dictate which consumers may receive a particular offer. These parameters can involve past purchases, income level, location, likelihood of purchase, and other consumer data.

From an advertiser user's perspective, the connection and communication platform may receive a trigger notification of a future purchase of an item type. The future purchase may be associated with a consumer user device (e.g., a consumer user, user account, printed receipt, client data associated with the user, etc.). Upon receiving the trigger notification, the connection and communication platform may initiate a matching procedure that correlates the item type with a set of advertisements generated by an item advertiser (e.g., received in an advertising exchange computer network, etc.). The connection and communication platform may provide the set of advertisements to the consumer user device and receive a selection of one more advertisement(s) from the set of advertisements. The selection may identify an item identifier associated with the first advertisement that will be acquired as the future purchase in association with the consumer user device. In some examples, the alert notification is an advertisement to apply the future purchase.

From a consumer user's perspective, the connection and communication platform may be associated with a software application installed at the client user device (e.g., consumer user device, used interchangeably) that provides a search tool. This software application may be tailored to a mobile device or other client user device. The consumer user can provide a search term to the application where the search term corresponds with an item type. The application and/or connection and communication platform may initiate a matching procedure that correlates the item type with a set of advertisements from a set of item manufacturers (e.g., received in an advertising exchange computer network, etc.), vendors, merchants, or other parties that may provide advertisements for items. The application and/or connection and communication platform may provide the set of advertisements to the client device and receive a selection of one or more advertisement(s) from the set of advertisements. The selection may identify an item identifier associated with the first advertisement that will be acquired as a future purchase in association with the client device. In some examples, the future purchase is limited to a predetermined time frame from receiving the selection of the first advertisement. In some examples, the application and/or connection and communication platform may receive a confirmation of the future purchase from the client device and initiate a credit transfer to a wallet account associated with the client device.

Various technical advantages are provided throughout the disclosure. For example, the connection and communication platform may help reduce electronic processing and communications by associating a future purchase (e.g., that the consumer user pre-emptively identifies) with an advertisement for the item type involved in the future purchase. The connection and communication platform may not need to process millions of digital interactions between the consumer user device and other platforms (e.g., social media, purchase histories, etc.) in order to predict or infer what item type(s) the user might purchase within a limited time frame, because the consumer user may explicitly inform the connection and communication platform of this future purchase information, where the information would not have been generated previously. The connection and communication platform may simplify the complex advertising process by directly generating data from the consumer user in exchange for a reward (e.g., transferring funds to a digital wallet associated with the consumer user), resulting in fewer processing resources needed to determine this information, fewer electronic communications and models, and improved data accuracy and consumer users' transactional conversion ratios overall.

Additionally, the connection and communication platform can facilitate generating and transmitting communications between the merchant, advertiser, and consumer user devices associated with a future purchase that is initially identified by the consumer user. The consumer user may start the clock essentially in generating and transmitting these communications, which can further reduce processing of unnecessary communications and data processing, which can free up processing capability for other tasks. Upon triggering the process from the action performed by the consumer user (e.g., identifying the item that the consumer user plans to purchase within a limited time frame), the connection and communication platform can start matching and limiting the advertisements and communications to items within the time frame initiated by the consumer user.

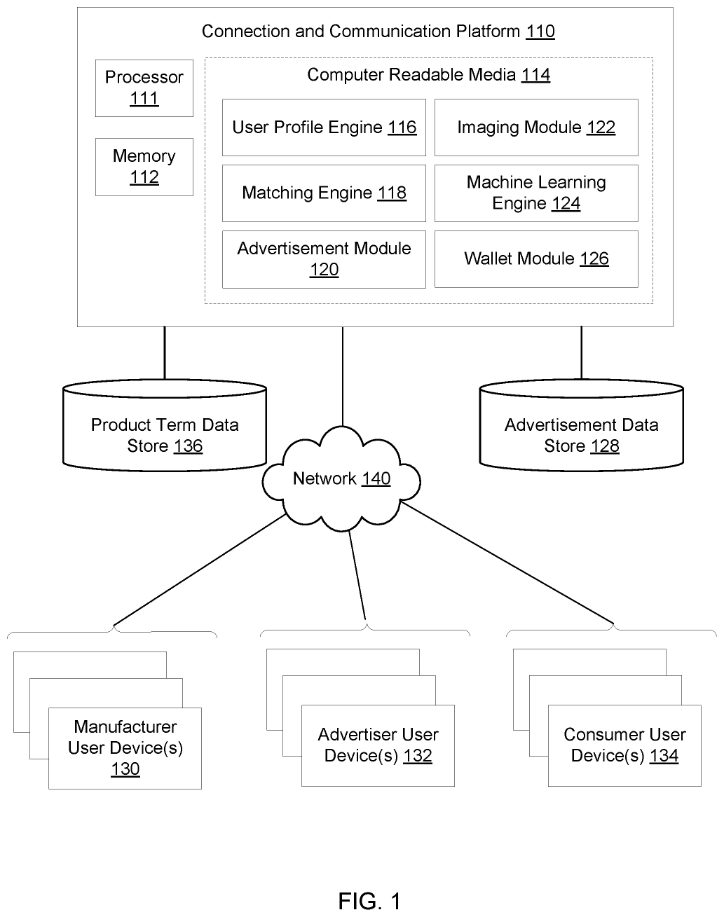

FIG. 1 is an illustrative connection and communication platform, in accordance with the embodiments disclosed herein. The system may comprise connection and communication platform 110 in communication with one or more manufacturer user devices 130, one or more advertiser user devices 132, and one or more consumer user devices 134 via network 140. Connection and communication platform 110 may include processor 111, memory 112, and computer readable media 114 comprising a plurality of engines and modules to enable functionality described throughout the disclosure. For example, computer readable media 114 may include user profile engine 116, matching engine 118, advertisement engine 120, imaging module 122, machine learning engine 124, and wallet engine 126.

Any of the users discussed herein may access connection and communication platform 110 via network 140 using manufacturer user device 130, advertiser user device 132, and consumer user device 134 (e.g., mobile device, personal computer, etc.) for various purposes. For example, manufacturer user device 130 may interact with connection and communication platform 110 to provide a list of items that are available for future purchases (e.g., including manufacturer of items, data processor, reseller of items, etc.). In another example, advertiser user device 132 may interact with connection and communication platform 110 to receive a list of items to advertise for future purchases and provide a set of advertisements for those items. In another example, consumer user device 134 may interact with connection and communication platform 110 to receive the set of advertisements and provide a selection of one or more advertisements or items.

User profile engine 116 is configured to generate a user profile for one or more users, including users associated with one or more manufacturer user devices 130, one or more advertiser user devices 132, and one or more consumer user devices 134. The user profile may comprise user device information for the device that is operated by the user (e.g., a device or mobile identifier, Service Set Identifier (SSID), Identifier for Advertisers (IDFA), etc.).

The user information may be associated with a plurality of characteristics. Some of the user information may be based on the user type. For example, a manufacturer user may be associated with a name (e.g., individual or company entity, etc.) and one or more items the user manufacturers. In another example, an advertiser user may be associated with a name (e.g., individual or company entity, etc.) and one or more items the user advertises. In another example, a consumer user may be associated with a name (e.g., individual or company entity, etc.), one or more items the user plans to identify as a future purchase, advertisement history, order history, and other relevant information.

Matching engine 118 is configured to receive a search term that corresponds with an item type and initiate a matching procedure that correlates the item type with various information. The search term may be received from consumer user device 134 or other client device. In some examples, the matching procedure may correlate the item type with an item identifier in an item database of an item manufacturer associated with manufacturer user device 130. In some examples, the matching procedure may correlate the item type with a set of advertisements from a set of item manufacturer (or merchants, vendors, other parties that generate advertisements, etc.).

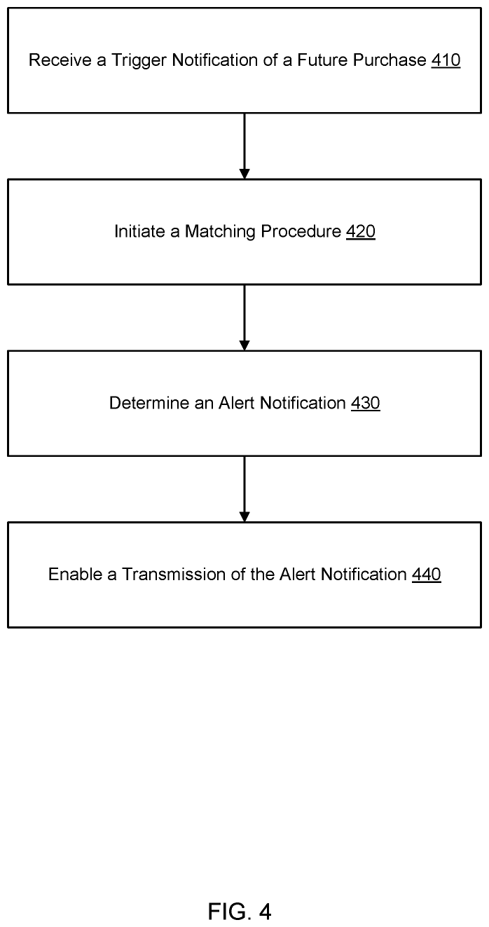

Matching engine 118 is also configured to receive the item type from consumer user 134 and route the item type to an advertising exchange computer network 450 illustrated in FIG. 4 and associated with a plurality of advertiser user devices 132. The advertising exchange computer network may be a distributed set of computing devices, each of which are associated with a single advertiser user device 132. In some examples, the advertising exchange computer network may correspond with a digital marketplace that enables a plurality of advertiser user devices 132 (e.g., including advertisers, publishers, offer/coupon entities, affiliate networks, etc.) to buy and sell advertising space in real-time (e.g., through a real-time auction of the advertising space, etc.).

In some examples, advertisements may be provided by the plurality of advertiser user devices 132 and matching engine 118 can select one or more advertisements that match the item type selected by consumer user device 134. These selected advertisements may be provided to consumer user device 134.

In some examples, matching engine 118 can provide the item type to the advertising exchange computer network (e.g., as a real-time request that is posted or distributed to the network) and the plurality of advertiser user devices 132 may provide one or more advertisements in response. Matching engine 118 may receive the generated advertisements and confirm that the item type included in the advertisement matches the item type requested (e.g., via OCR, parsing algorithm, etc.). In some examples, the item type can be considered a user keywords that is matched to information included in the advertisement that is relevant to the consumer user. These selected advertisements may be provided to consumer user device 134.

Advertisement module 120 is configured to generate an advertisement for advertiser user device 132 and/or receive an advertisement from a third party (e.g., the advertising exchange computer network, etc.). The advertisement may comprise an item identifier, a manufacturer, a value (e.g., a discount offer to apply to the price of a future purchase for a particular item type, a coupon to provide to an item manufacturer for a particular item type, etc.), a monetary reward, and a time range that the advertisement is active. The advertisements may be stored in advertisement data store 128 (e.g., item type, advertisement information, time frame, manufacturer, etc.).

Advertisement module 120 is also configured to provide a set of advertisements to a client device. The device (e.g., consumer user device 134) may display the advertisements at the graphical user interface and allow interaction with the advertisements. The advertisement may be selected by consumer user device 134 and the selection may be transmitted back to advertisement module 120. Advertisement module 120 may associate the advertisement with the consumer user.

Advertisement module 120 is also configured to filter advertisements based on a location of consumer user device 134. For example, a geolocation (dynamic) and/or mailing location (static) may be identified for consumer user device 134. The advertisements within a location range may be determined and provided to consumer user device 134 for selection. In another example, the advertisement may be targeted to the consumer user device based on previous interaction activities, consumer user characteristics, or other features that may correlate the advertisement to the consumer user.

Advertisement module 120 is also configured to determine a time range for applying the advertisement to the future purchase. For example, a selection of an advertisement may be received. The time range may start when the selection is received. The advertisement may be applied to the future purchase for a predetermined time range (e.g., 24 hours, etc.) such that the discount associated with the advertisement may only apply if a confirmation of the future purchase is received within the time range (e.g., an image of a sales receipt from the manufacturer, etc.).

Imaging module 122 is configured to receive an image that identifies a proof of the future purchase. The image may be analyzed (e.g., using optical character recognition (OCR), etc.) to identify components of the image, including an item, item identifier, item type, merchant name, merchant address, and other information pertaining to the future purchase. The item type (e.g., generic item, specific item, activity or event for using the item, etc.) may be matched with an item type in an advertisement transmitted to consumer user device 134 (by matching engine 118).

Machine learning engine 124 is configured to determine a likelihood of success of completing the future purchase in association with the advertisement between the manufacturer user, advertiser user, and consumer user. For example, the connection and communication platform may identify that the consumer user is ninety percent likely to complete the future purchase that it identified in the time range (e.g., user characteristic), so the advertisement may be selected or altered based on this information (e.g., less discount or rewards values, expanded models available corresponding to the item type, etc.). The determination that the consumer user is a percentage likelihood to complete the future purchase may be based on analyzing historical purchase data, completing a purchase of the item that the consumer user identified as intending to purchase later in the day, and/or other methods described herein related to the purchase likelihood score. In some embodiments, the historical purchase data can show the number of offers transmitted to the consumer device compared to the number of offers redeemed to determine a likelihood of purchase.

As a sample illustration, the purchase history of the consumer user may comprise a monthly purchase of a particular brand of cereal. The input to machine learning engine 124 may identify the selection of the cereal item type by the consumer user, while the output from machine learning engine 124 may identify a higher likelihood of a future purchase of the consumer user in accordance with the pattern. In response to the output, the discount value of the advertisement may be adjusted to provide a lower value when the consumer user identifies that it intends to initiate a future purchase for the cereal item type. In another example, the discount value of the advertisement may be adjusted higher to encourage the consumer user to switch brands from the recurring particular brand of cereal to a new brand.

Machine learning engine 124 is also configured to determine availability and/or filtering of advertisements and items. For example, machine learning engine 124 can review the time limitations associated with the advertisements to determine if an advertisement had expired. Similarly, machine learning engine can determine what items are associated with a particular advertisement. If a consumer user provides a particular item type, machine learning engine 124 can review the items associated with an advertisement and refrain from displaying any advertisement that does not include the particular item type. Machine learning engine 124 may also rely on combinations of item types to further filter the number of advertisements that may be available to the consumer user.

Wallet module 126 is configured to track funds associated with users. For example, a first digital wallet may be associated with consumer user device 134 and a second digital wallet may be associated with advertiser user device 132 or platform operator. When the proof of the future purchase is received (by imaging module 122), wallet module 126 may initiate a transfer of funds to the first wallet (e.g., associated with consumer user) from the second wallet (e.g., associated with advertiser user) as payment/reward for completing the future purchase. The funds from the digital wallet may be transferred to a digital wallet or account that is external to connection and communication platform 110 as well (e.g., via Automated Clearing House (ACH) transfer, etc.).

In some examples, wallet module 126 may generate and transmit a function call to a third party entity (e.g., Plaid®) to maintain the digital wallet. For example, wallet engine 126 may interface with consumer user device 134 to determine the advertisements and/or offers and the values of funds to be added to the digital wallet of the consumer user. Wallet engine 126 can generate an encrypted and/or digitally signed electronic message to identify the funds to transfer from a first wallet to a second wallet (which are maintained by the third party entity), interact with the third party entity to provide security restricting access to the funds, and the like. The third party entity can interface with issuer banks or other entities to implement the exchange of funds.

In some examples, wallet module 126 may correspond with a third party entity to supplement a verification of a future purchase. This may be verification process may be in addition to or in lieu of imaging module 122.

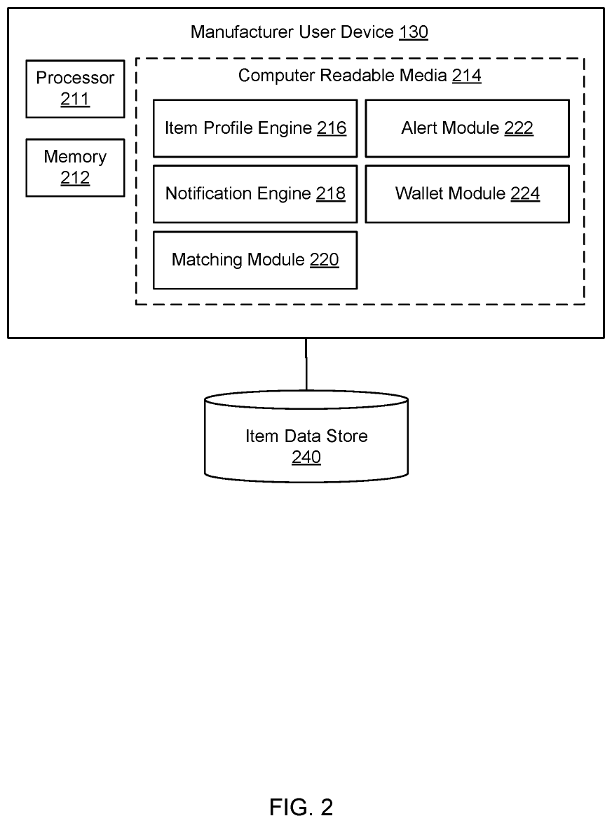

FIG. 2 is an illustrative manufacturer user device, in accordance with the embodiments disclosed herein. As illustrated, some of the processing may be implemented at manufacturer user device 130 or may remain at connection and communication platform 110. Manufacturer user device 130 may include processor 211, memory 212, and computer readable media 214 comprising a plurality of engines and modules to enable functionality described throughout the disclosure. Processor 211, memory 212, and computer readable media 214 of FIG. 2 may be similar to processor 111, memory 112, and computer readable media 114 of FIG. 1, respectively.

Item data store 240 may comprise information on a plurality of items that the manufacturer users provides for future purchases for consumer users. Information on the plurality of items may comprise, for example, item name, item type, item description, image (e.g., of the item to add to the advertisement, etc.), location to purchase the item (e.g., URL, physical location, etc.), stock keeping unit (SKU), and price.

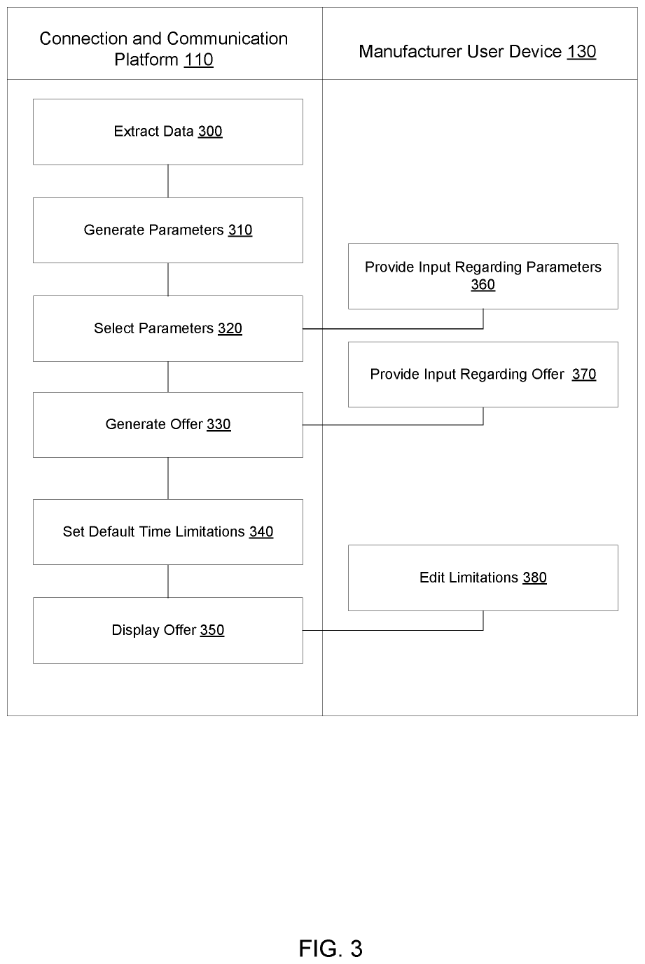

FIG. 3 illustrates an example process for generating parameters and creating new offers. These parameters are generated based on a plurality of data, including consumer account data from debit accounts, credit accounts, and gifts. The consumer user may provide information on one or more accounts to the electronic wallet 126 as described below.

At block 300, data may be extracted by connection and communication platform 110. This may occur automatically when a consumer user provides account information as described above. Extracted data can include data from the time the consumer user adds the account to the application. Using this data, the connection and communication platform is able to set parameters based on age, gender, credit score, past purchases, income level, location, likelihood of purchase, the total expenditures of a particular consumer, and other consumer data. This data is also used to update a consumer user's profile with rough demographic information. Additional information for the consumer user's profile can also include demographic information, shipping information and other information provided by a consumer user. As described further below, this profile may also include a “basket of items”, a data store to represent a consumer user's recurring purchases. The consumer user's profile associates with the parameters in order to determine whether a particular consumer user is a good match for a particular offer.

At block 310, parameters may be generated by connection and communication platform 110. The connection and communication platform 110 may provide an interface for the manufacturer user to set parameters for generating offers for a consumer. These parameters can include product terms (e.g. shoes, dresses), brand names, “near me” in combination with a particular manufacturer, and any other search terms a consumer may use to locate a preferred product. These parameters aid the connection and communication platform in generating a set of rules that will dictate the algorithm for future consumers.

The parameters used to generate offers may be generated based on a plurality of data, including consumer account data from debit accounts, credit accounts, and gift accounts. The consumer user may provide one or more account identifiers to the electronic wallet 126 as described below. The consumer user's profile associates with the parameters in order to determine whether a particular consumer user is a good match for a particular offer. The connection and communication platform 110 updates the consumer user's profile as a consumer user attempts to redeem offers. For example, if an “offer” expires such that the consumer user cannot redeem a reward, the application can record that expiration to generate a consumer user's likelihood of purchase. This can result in a “purchase likelihood score”, which the manufacturer user can use to set a required minimum score to redeem an offer. The score can be automatically updated each time an offer either expires or is redeemed. In some examples, the purchase likelihood score may be presented at a display of the consumer user device or otherwise made available to the consumer to encourage the consumer to improve the score. A likelihood of purchase score can be valuable for a manufacturer user who can direct advertisements to consumer users that are more likely to purchase an item. The application installed with the consumer user device can also store a consumer user's search history within the application and/or transmit it to connection and communication platform 110. A manufacturer user may use this history to determine if the consumer user would be more interested in their product.

The connection and communication platform 110 also comprises a filtering function to narrow a subset of consumer users to offer a particular discount. For example, the filtering function may be used to select an advertisement for a particular store location and generate an offer to consumer users within a certain distance of store. This offer may automatically appear to a particular consumer user when they enter within the distance of the store. This offer can be time limited to match the particular store's closing time, to signal a one day offer. As another example, the manufacturer user may choose to provide a higher discount offer if a consumer user has a high rate of successfully redeeming offers on the application. As another example, a single product can have multiple different offers depending on the parameters set for the consumer user. An offer can be designated for college graduates in San Diego based on the location and education level. A second offer can offer additional discounts to consumer users who have a larger purchase history associated with the brand, which can be monitored by recording the SKUs for products of a redeemed offer. A third offer can offer additional discounts to consumer users who have the item in their weekly basket of items as described above. The connection and communication platform 110 can alter the time period for an offer. If a holiday occurs during that week, the offer may change to support any holiday sales. The connection and communication platform 110 generates offers based on the parameters set, but the manufacturer user will still have ultimate control to alter these offers as necessary.

The connection and communication platform 110 can also receive information to preset filtering groups of consumer users and set an offer amount for that group prior to receiving a notice of an imminent purchase from the consumer. The preset groups alleviate the manufacturer's burden of waiting for an imminent purchase. Once the preset groups are selected, the manufacturer user does not have to use the application as often to take advantage of offers. The connection and communication platform 110 will take all preset group and parameters into consideration and fulfill the advertising task for the manufacturer.

At block 320, once a manufacturer user selects a consumer user or group of consumer users, the manufacturer or advertiser user submits a proposed offer. This proposed offer, or “bidding”, allows a manufacturer user to raise offer prices in an effort to secure more consumer users or redemptions. The connection and communication platform 110 can receive these proposed offers and notify the manufacturer user how their bid compares to other manufacturers or advertiser users, with a focus on the highest cash back for a consumer user. For example, an offer may be displayed in front of other offers because the offer holds the most redemption value. The manufacturer user is capable of viewing this hierarchy and can adjust their individual offer accordingly if it is preferred to be higher on the list. The connection and communication platform can set a time limit for this bidding process or can allow the hierarchy to change indefinitely, in accordance with the time limitations for the particular offer. In this case, the list can dynamically add new offers as other offers expire. A similar display would appear on the consumer user device as they search for a particular product.

At block 360, input regarding the parameters may be provided by manufacturer user device 130. These offers can vary based on any applicable parameters and the connection and communication platform 110 can receive additional input to alter the time limitations for these offers based on any parameters. The connection and communication platform 110 aids the application in generating a dynamic display based on the parameters, using a plurality of data such as product images, product descriptions, original prices before applying an offer, discounted prices, delivery methods, and additional terms of an offer. Once parameters are available, the manufacturer user can select which parameters to focus advertisements towards by providing input associated with one or more parameters generated by connection and communication platform 110. For example, out of a large selection of parameters, the manufacturer may select an age group between 18-25, select people who are still in college, and select an annual income level of $50,000.

At block 370, the manufacturer user can provide input to generate the offer. For example, the manufacturer user can provide an offer title, the amount of cash back, an offer description, and/or a delivery method.

At block 330, the connection and communication platform 110 can generate an offer. As described above this offer can be based on input from the manufacturer user and other parameters generated by the platform.

At block 340, once an offer is generated, the connection and communication platform 110 may set a default time limitation for the offer. This can be predetermined either by the manufacturer user or a system default. The manufacturer user can edit these time limitations as needed, as illustrated through block 380. For example, the manufacturer may set a time limitation for 24 hours to account for Black Friday shopping. As another example, an event may be happening close by, so the offer can be limited to the duration of the event. Once time limitations are confirmed, the connection and communication platform can then display the offer 1150 to consumers in accordance with the consumer interface. At block 350, the offer can be displayed to the consumer user in accordance with the time limitation.

The example process may be implemented with or without a notification of a future purchase from a consumer user. As described above, the connection and communication platform 110 may initiate a matching procedure that correlates the item type with an item identifier in an item database of an item manufacturer or alternative third-party data source. This matching procedure can be tied to the data extraction 310 and generation of parameters 320. The connection and communication platform 110 may determine an alert notification associated with the item identifier of the item manufacturer and enable transmission of the alert notification to the consumer user.

The purchase likelihood score described herein can also affect a manufacturer user or advertiser user's offer value to the particular consumer user. The manufacturer or advertiser users can have access to the consumer profile to determine whether the purchase likelihood score exceeds a threshold value, indicating a high likelihood of purchase. When determining which individual consumer users will receive offers, the manufacturer or advertiser user is capable of reviewing the purchase likelihood scores, allowing them to select consumers based on that score. This selection can be done through individual review of the consumer profile or through a filtering function that limits available consumers based on the purchase likelihood score. Alternatively, the manufacturer or advertiser user is also capable of altering a potential offer based on the purchase likelihood score. The manufacturer or advertiser user may provide a similar offer to multiple consumer users, but tailor the offer to increase rewards based on a higher purchase likelihood score through manufacturer input, described further below.

FIG. 4 is an alternative process for manufacturer user device 130, in accordance with the embodiments disclosed herein. In some examples, the process illustrated may be performed by connection and communication platform 110 on behalf of manufacturer user device 130 that interacts with the connection and communication platform.

At block 410, a trigger notification may be received. For example, connection and communication platform 110 may receive a trigger notification of a future purchase of an item type. The future purchase may be associated with a client device (e.g., consumer user device 134).

At block 420, a matching procedure may be initiated. For example, connection and communication platform 110 may initiating a matching procedure, as described above, that correlates the item type with an item identifier in an item database of an item manufacturer. The matching procedure may be initiated upon receiving the trigger notification.

At block 430, an alert notification may be determined. For example, connection and communication platform 110 may determine an alert notification associated with the item identifier of the item manufacturer.

At block 440, a transmission of the alert notification may be enabled. For example, connection and communication platform 110 may enable the transmission of the alert notification to the client device.

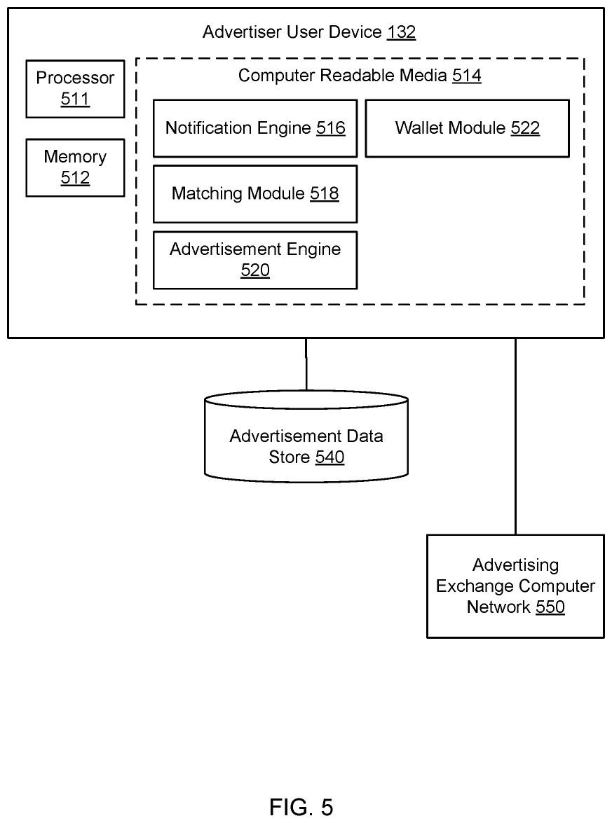

FIG. 5 is an illustrative advertiser user device, in accordance with the embodiments disclosed herein. As illustrated, some of the processing may be implemented at advertiser user device 132 or may remain at connection and communication platform 110. Advertiser user device 132 may include processor 511, memory 512, and computer readable media 514 comprising a plurality of engines and modules to enable functionality described throughout the disclosure. Processor 511, memory 512, and computer readable media 514 of FIG. 5 may be similar to processor 111, memory 112, and computer readable media 114 of FIG. 1, respectively.

Advertisement data store 540 may comprise information on one or more advertisements available to provide to consumer users. The advertisement(s) may be selected based on an item type identified by the consumer user to apply to a future purchase. Information on the plurality of advertisements may comprise, for example, item name, item type, item description, advertisement image (e.g., to display at the consumer user device, etc.), time range that limits the applicability of the offer, and price. The advertiser user device 132 may also be connected to an advertising exchange computer network 550. This advertising exchange computer network can allow multiple advertiser users to access the connection and communication platform to place “bids” for advertisements as described above.

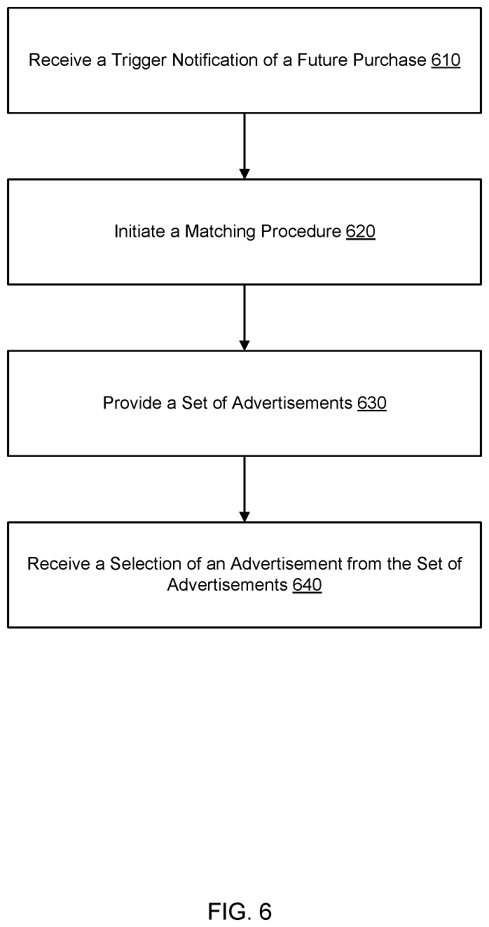

FIG. 6 is an illustrative process for an advertiser user device, in accordance with the embodiments disclosed herein. In some examples, the process illustrated may be performed by connection and communication platform 110 on behalf of advertiser user device 132 that interacts with the connection and communication platform.

At block 610, a trigger notification may be received. For example, connection and communication platform 110 may receive a trigger notification of a future purchase of an item type. The future purchase may be associated with a client device (e.g., consumer user device 134).

At block 620, a matching procedure may be initiated. For example, connection and communication platform 110 may initiating a matching procedure that correlates the item type with a set of advertisements generated by an item advertiser (e.g., advertiser user device 132). The matching procedure may be initiated upon receiving the trigger notification.

At block 630, a set of advertisements may be provided. For example, connection and communication platform 110 may provide the set of advertisements to the client device (e.g., consumer user device 134).

At block 640, a selection of an advertisement may be received. For example, connection and communication platform 110 may receive a selection of a first advertisement from the set of advertisements. The selection may identify an item identifier associated with the first advertisement that will be acquired as the future purchase in association with the client device.

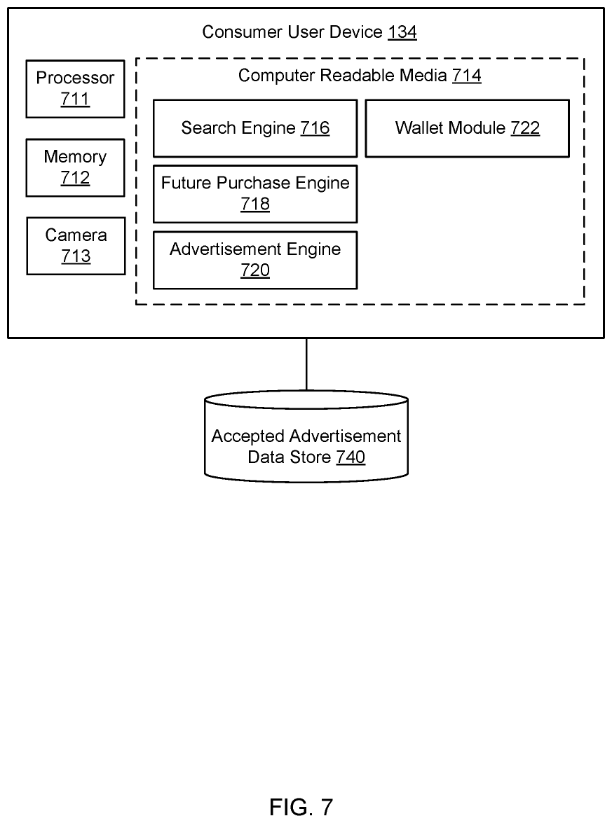

FIG. 7 is an illustrative consumer user device, in accordance with the embodiments disclosed herein. As illustrated, some of the processing may be implemented at consumer user device 134 or may remain at connection and communication platform 110. Consumer user device 134 may include processor 711, memory 712, camera 713, and computer readable media 714 comprising a plurality of engines and modules to enable functionality described throughout the disclosure. Processor 711, memory 712, and computer readable media 714 of FIG. 7 may be similar to processor 111, memory 112, and computer readable media 114 of FIG. 1, respectively.

Camera 713 may be configured to capture an image of a receipt or other proof of a purchase. Camera 713 may generate the image and, in some examples, may initiate an optical character recognition (OCR) process to recognize the text included in the image. The image and/or text associated with the image may be transmitted to connection and communication platform 110 for further analysis (e.g., confirming that the item purchased is the same item associated with the advertisement selected by the consumer user, etc.).

Accepted advertisement data store 740 may comprise information on one or more advertisements selected by the consumer user to apply to a future purchase. Additional data may be received from account information such as debit accounts, credit accounts, or gifts. When a consumer user uses the application, they can provide account information which allows the connection and communication platform to view past credit account purchases to determine whether the consumer validly redeemed an offer by purchasing a specific product. For example, if an offer requires a consumer user to spend a certain amount at a particular store, the connection and communication platform may analyze the consumer user's credit data to find a purchase made at that store using the added credit account. If that purchase exceeds the requirement, the connection and communication platform may then trigger the refund process to reward the consumer user for redeeming the offer. Furthermore, the consumer user may directly provide information such as demographic information, shipping information, and other personal consumer data. The consumer user also provides data on applicable advertisements.

Information on the plurality of advertisements may comprise, for example, item type, item description, time range that limits the applicability of the offer, start time of the time range (e.g., when the advertisement was selected), end time of the time range (e.g., when the advertisement will expire), and price.

Purchases made by the consumer user can generate new data to add to a “basket of items,” a data store to represent a consumer's recurring purchases. Using a GUI function locally at consumer user device 134, the connection and communication platform 110 can automatically trigger a display of offers based on the perceived frequency of a particular item. For example, if a consumer frequently buys shoes, the connection and communication platform 110 can analyze the corresponding purchase history data based on the frequency of an item or type of item, determine if the frequency of purchase exceeds a threshold value, and automatically display more shoe offers based on the determination. The frequency can be tailored to a specific item via a SKU number or item description, or can broaden to include particular brand items. If the consumer buys a particular brand or type of shoe, the connection and communication platform can identify this trend and update the display accordingly. For example, a consumer may frequently purchase the same ballet shoes for practice. The connection and communication platform 110 can identify the SKU number associated with that item and provide offers to incentivize the consumer to purchase another brand with a similar ballet shoe. As another example, a consumer may exclusively purchase dress shoes from a company due to their comfort. The connection and communication platform 110 can recognize this trend and provide offers for other types of comfortable shoes. Ultimately, the connection and communication platform gears advertisements towards maximizing the cash back to a consumer while also maximizing a particular manufacturer's number of purchases through machine learning. The connection and communication platform 110 maximizes the cash back to a consumer by displaying high reward offers before lower offers, wherein the high reward offers generally involve purchases outside of the consumer's trends. The connection and communication platform 110 may focus on potential new consumers and incentivizes consumers to avoid following a purchase trend. This focus may guide the connection and communication platform 110 to consumer users based on the number of purchases recorded through the software application. For example, if a consumer user has zero recorded purchases with a particular manufacturer, the platform may match the consumer user with the respective manufacturer user.

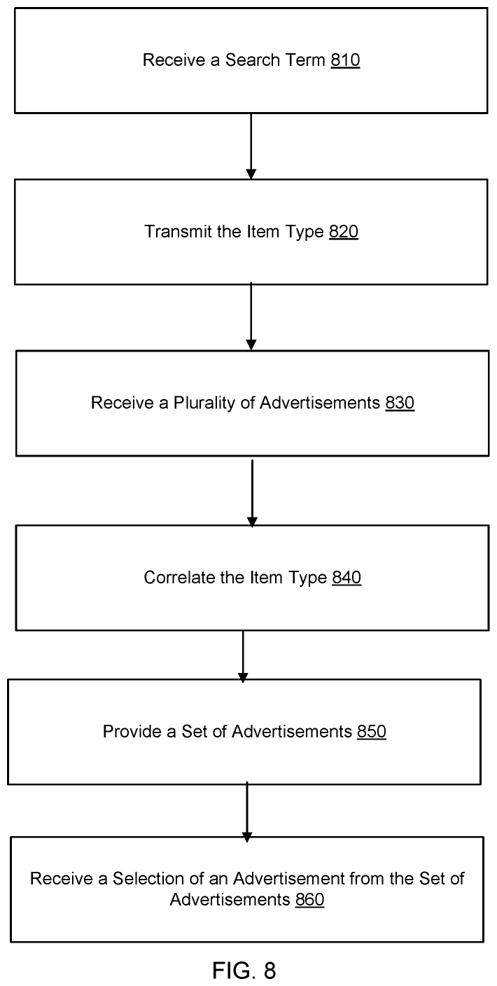

FIG. 8 is an illustrative process for a consumer user device, in accordance with the embodiments disclosed herein. In some examples, the process illustrated may be performed by connection and communication platform 110 on behalf of consumer user device 134 that interacts with the connection and communication platform or by a software application that is uploaded locally to consumer user device 134.

At block 810, a search term may be received. For example, connection and communication platform 110 may receive a search term from a consumer user (e.g., consumer user device 134). The search term may correspond with an item type (e.g., “jeans,” “books,” etc.).

At block 820, the corresponding item type is transmitted to an advertising exchange computer network associated with a plurality of advertiser user devices. As described above, this advertising exchange computer network allows multiple advertisers to place “bids” for advertisements that will be generated for the consumer user.

At block 830, the connection and communication platform 110 receives a plurality of advertisements transmitted from the plurality of advertiser user devices, in accordance with the bidding process described above.

At block 840, the connection and communication platform 110 correlates the item type with one or more advertisements from the plurality of advertisements. This may be determined based on the parameters or search criteria as described above.

At block 850, a set of advertisements may be provided. For example, connection and communication platform 110 may provide the set of advertisements to the client device.

At block 860, a selection of an advertisement from the set of advertisements may be received. For example, connection and communication platform 110 may receive a selection of a first advertisement from the set of advertisements. The selection may identify an item identifier associated with the first advertisement that will be acquired as a future purchase in association with the client device.

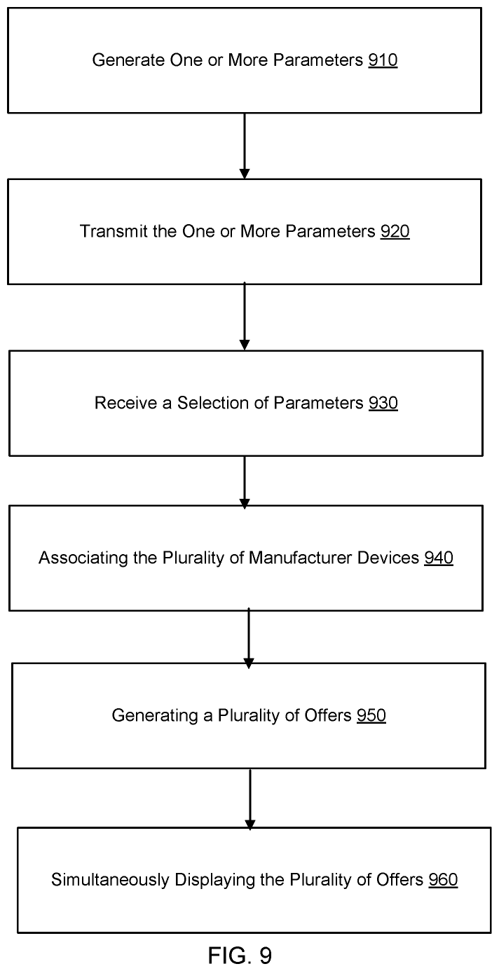

FIG. 9 is an illustrative process for a manufacturer user device, in accordance with the embodiments disclosed herein. In some examples, the process illustrated may be performed by connection and communication platform 110 on behalf of manufacturer user device 130 that interacts with the connection and communication platform or by a software application that is uploaded locally to manufacturer user device 130.

At block 910, one or more parameters are generated. As described above, this can be generated automatically or through input from the manufacturer user. The parameters may involve a variety of consumer user data, including data on credit accounts, past purchase history, and other relevant data.

At block 920, the corresponding parameters is transmitted to an manufacturer exchange computer network associated with a plurality of manufacturer user devices. Like the advertisement exchange computer network described above, the network here involves a plurality of manufacturer users. The plurality of manufacturer users can receive these parameters, which may determine what offers are generated. Furthermore, as described above, the network can displaying offers to a consumer user based on the parameters from the one or more manufacturer users, where the manufacturer user can see where their offer is located.

At block 930, the connection and communication network 110 receives a selection of parameters from the manufacturer user. As described above, this selection may be made in accordance with an item type or a type of consumer user desired for a particular offer. Furthermore, this may be accomplished automatically, as the manufacturer user can preselect parameters, such that the connection and communication network 110 can determine whether to select a particular parameter in the future.

At block 940, the connection and communication platform 110 associates the plurality of manufacturer devices with the consumer device. As described above, this can be accomplished through comparing parameters so the selected parameters align with the consumer user's profile or a particular item type.

At block 950, the connection and communication platform 110 generates a plurality of offers based on the associations. As described above, the offers may be generated through manufacturer input, or may automatically generate given the manufacturer user's chosen parameters.

At block 960, the plurality of offers are displayed on the consumer user device. The display may take the form of a feed that the consumer user can scroll through to review all offers. Alternatively, all offers can be displayed in “pages” of multiple offers. The consumer user may select and redeem an offer in accordance with the embodiments described herein.

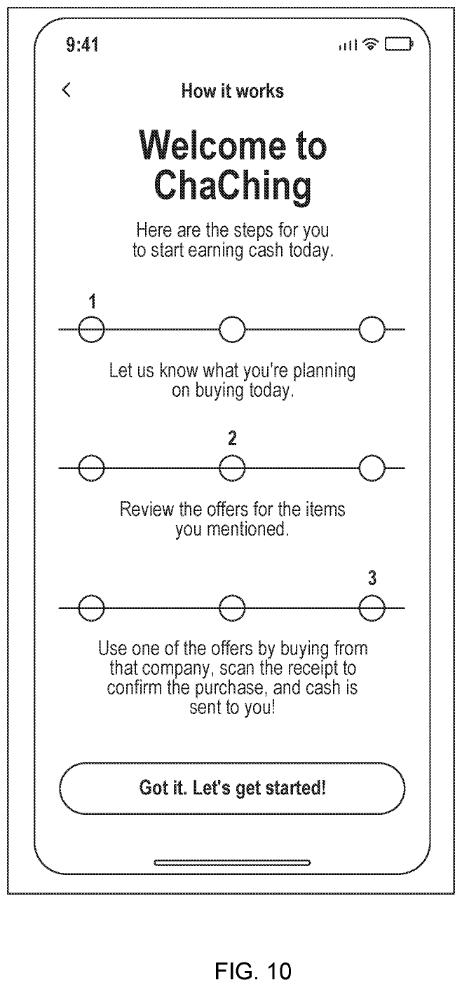

FIGS. 10-12 are illustrative interfaces to interact with the connection and communication platform, in accordance with the embodiments disclosed herein. For example, a software application or web browser may be incorporated with consumer user device 134. When activated, the application or web browser may display an initial screen.

The user interface may provide instructions to a consumer user regarding interactions with connection and communication platform 110. For example, the instructions may request that the consumer user provide an indication of one or more items that they plan to buy. Connection and communication platform 110 may provide advertisements (e.g., “exclusive deals”) from companies (e.g., manufacturer user device 130) to the consumer user after an indication is made.

The user interface may provide instructions to set up a digital wallet. For example, the instructions may request that the consumer user provide an account number associated with an issuing entity bank that can be linked to the digital wallet provided by connection and communication platform 110. Connection and communication platform 110 may store the account information with a user profile of the consumer user.

As illustrated in FIG. 10, a user interface may provide instructions to consumer user device 134 regarding a registration process. For example, the registration process can include a user interface that includes instructions for the consumer user on how to initiate interactions with connection and communication platform 110. For example, the consumer user can provide a list of one or more items that the consumer user plans to include in a future purchase. In response to providing the list of items, connection and communication platform 110 can provide one or more advertisements or offers related to the item types included in the list of items. The consumer user may select one or more of the advertisements that are provided by connection and communication platform 110.

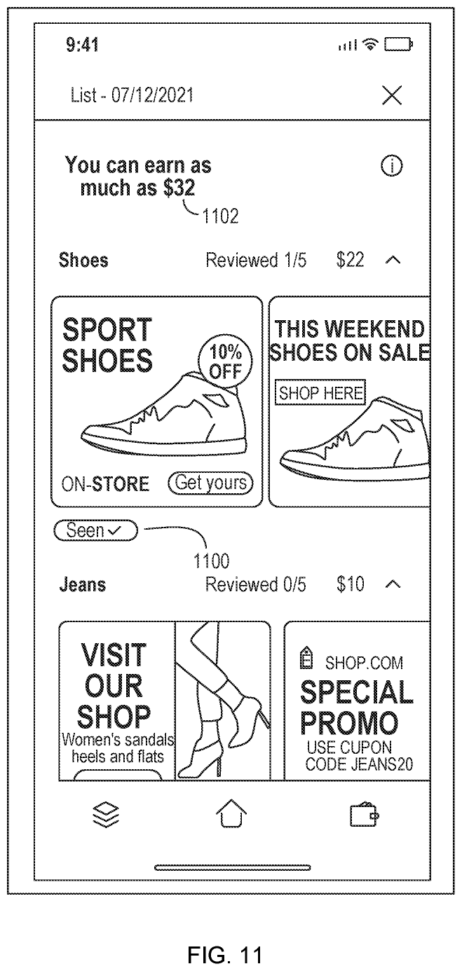

FIG. 11 illustrates a user interface to receive one or more advertisements associated with a list of items in a future purchase. For example, once the list of items is provided, connection and communication platform 110 can provide one or more advertisements associated with the items. The advertisements may provide discounts or funds in a consumer user digital wallet in exchange for a purchase of the items listed by the consumer user.

In some examples, a list of available advertisements 1100 may be provided. The consumer user may interact with the user interface to select one or more advertisements, which can be added to the selected advertisements. In some examples, the item type associated with each selected advertisement from list of available advertisements 1100 may be added to the user profile as well. The consumer user may interact with the user interface to provide one or more item types (e.g., select from a dropdown list, type an item description, recite an item name, etc.). The consumer user may provide the list of items and select “display offers” to submit the list of items to connection and communication platform 110.

In some examples, connection and communication platform 110 can provide an aggregated value 1102 associated with the advertisements. Aggregated value 1102 may determine a maximum discount value associated with a single item and add that maximum discount value to other maximum discount values associated with other items. Aggregated value 1102 may be displayed at the user interface.

In some examples, aggregated value 1102 may be transferred to the digital wallet of the consumer user when the consumer user satisfies the plurality of rules associated with each of the advertisements and/or connection and communication platform 110. For example, the plurality of rules may include, for example, the consumer user selects the plurality of advertisements associated with each maximum value, completes the purchase of the corresponding items within the time range limited by the advertisements, and provides a proof of the purchase (e.g., scanned receipts) to connection and communication platform 110. As described above, advertisements may be tailored to a consumer user's list of items in a future purchase. Once the list of items is provided, connection and communication platform 110 can provide one or more advertisements associated with the items. The advertisements may provide discounts or funds in a consumer user digital wallet in exchange for a purchase of the items listed by the consumer user. In this illustration, the advertisements may include images of a corresponding item, discount value, manufacturer or merchant information, and the like.

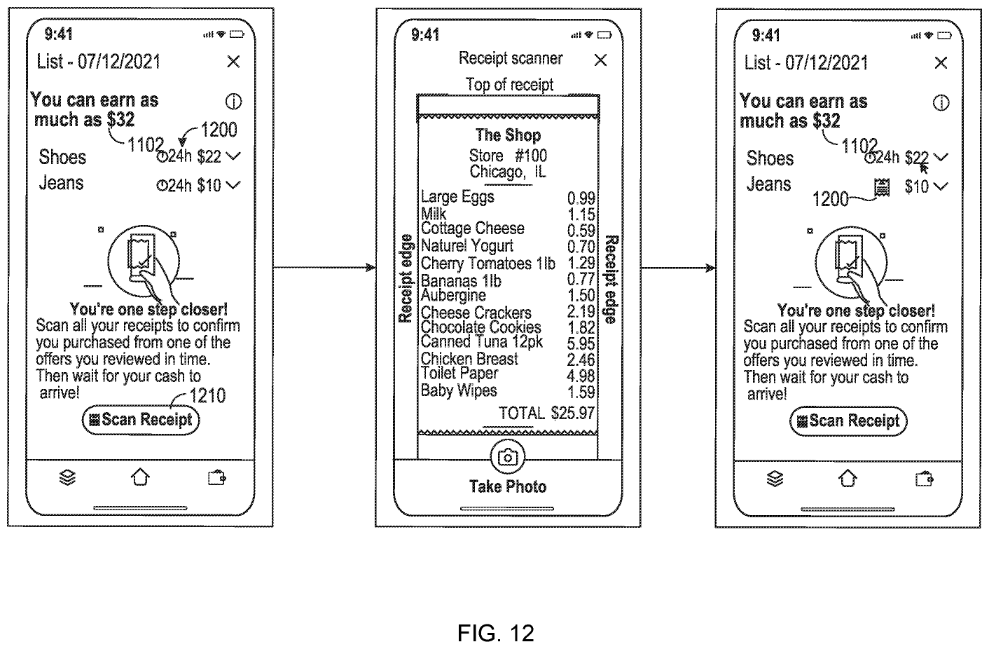

FIG. 12 illustrates a user interface to accept proof of purchase of items identified in the future purchase. At interface 1200, the consumer user may interact with the user interface to select one or more advertisements. The user interface may provide aggregated value 1102 based on the selected advertisements. The user interface may be updated to show one or more time ranges 1102 associated with each advertisement. Each time range 1202 may identify the time limit to provide proof of purchase of items identified in the future purchase. In some examples, the start time of the time range is when the consumer user selects the advertisement at the user interface. Time range 1202 may be tracked locally at consumer user device 134 (e.g., using the local clock or timer function) or remotely at connection and communication platform 110. The user interface may be minimized and continue tracking the time associated with the time range. When the consumer user initiates a purchase of an item associated with the advertisement, the consumer user can scan a receipt 1204 associated with the purchase and transmit that receipt (via consumer user device 134) to connection and communication platform 110.

Interface 1206 illustrates the user interface after the consumer user chooses to scan a receipt 1204. This may be accomplished by access to the consumer user device's camera or other media. The consumer user may select scanning tool 1204 to activate the camera of consumer user device 134, as illustrated in FIG. 12. The consumer user may provide the physical receipt within a digital window displayed at the user interface. The consumer user may activate the camera of consumer user device 134 to capture an image of the physical receipt. Interface 1206 may automatically process the photograph to initiate a consumer user's reward once an image is captured.

At interface 1208, the user interface can display an icon 1210 to demonstrate that a receipt has been scanned and/or accepted. For example, the proof of purchase may be received by connection and communication platform 110 and the user interface may be updated to identify confirmation 1210 of the received proof of purchase. In some examples, the aggregated value 1102 associated with the advertisement may be updated to identify the initiation of the transfer of funds to a digital wallet associated with the consumer user (e.g., change colors of the value, a checkmark, etc.). The digital wallet may comprise funds from one or more transfers associated with the consumer user. The funds from the digital wallet may be transferred to the digital wallet to an account that is external to connection and communication platform 110 (e.g., via Automated Clearing House (ACH) transfer, etc.). In some examples, the transfer of funds to an external account may be initiated automatically. In some examples, the time range associated with the item may be removed and updated with confirmation 1210, while other time ranges associated with advertisements that have not been satisfied may remain displayed.

The connection and communication platform 110 can initiate a transfer of funds from a first digital wallet to a second digital wallet associated with the consumer user. The consumer user may interact with the user interface to proceed with the registration process (e.g., selecting a tool that accepts the instructions and proceeds to additional user interfaces that receive consumer user information, account information, etc.). The user interface may provide additional instructions regarding the registration process. For example, the registration process can ask the consumer user what they plan on purchasing within a time range (e.g., the future purchase). The consumer user may interact with the user interface to provide one or more item types (e.g., select from a dropdown list, type an item description, recite an item name, etc.).

In some examples, a digital version of the receipt may be provided through a different source. For example, the camera of consumer user device 134 may not be used and the image of the receipt may be captured or generated by an external device (e.g., third party, digital receipt, etc.). In this instance, scanning tool 1010 may be configured to search for the digital version of the receipt (e.g., through a file explorer interface, etc.) and select the digital version as the proof of purchase of items identified in the future purchase.

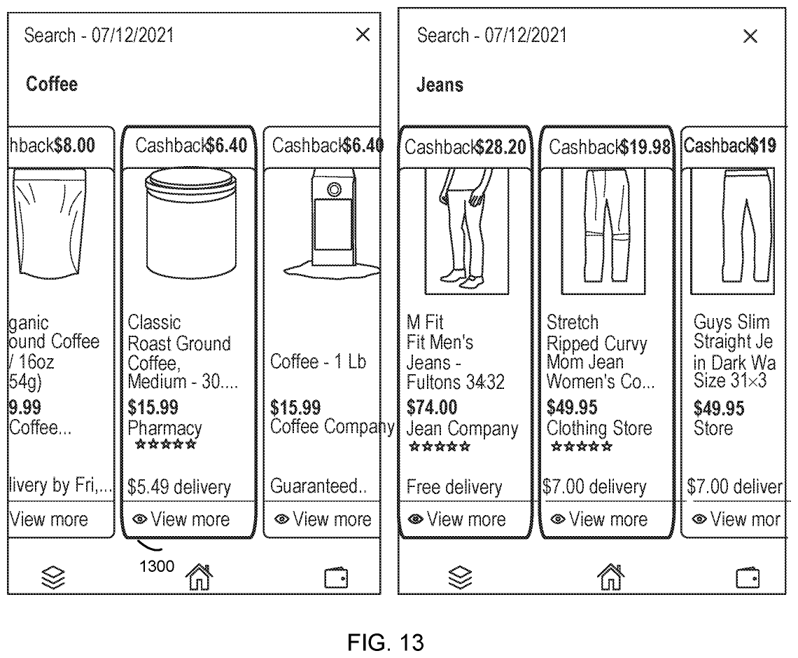

FIG. 13 illustrates a user interface after a consumer user searches for a particular product. Offers can be displayed in order of the highest cash back, which may correspond to a brand that the consumer user does not frequently purchase. Manufacturer users or advertiser users may also alter offers accordingly to change positions within this hierarchy in a “bidding” process. The connection and communication platform 110 may display the offer's current position in a hierarchy to a manufacturer or advertiser user. The connection and communication platform 110 may enable a search so the manufacturer user can view an offer's position for a given search result. The offers received from the search can then be displayed as a search feed, wherein a consumer user may swipe using a touch input to view additional offers. Each offer can be accompanied by a tab 1200 that displays additional information about the offer. In some embodiments, this tab 1300 may comprise a label underneath the product, such as “View More.” A consumer user may tap the “View More” tab to see offer details such as delivery method, time limitations, and purchase requirements. As mentioned above, the manufacturer user may be given a period of time to potentially increase the offer and move along the hierarchy of search results. The display may also dynamically change as offers expire, allowing a manufacturer user to increase and decrease offers as necessary. For example during the holiday season, a manufacturer user may increase the offer so they are displayed first on the hierarchy of search results. Once the holiday season completes, the manufacturer user may then decrease the offer and allow the offer to fall lower on the hierarchy. The manufacturer or advertiser user can ultimately hold the control over their offers to maximize the cash back to a consumer while maximizing the purchases made for the consumer.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 13. Various embodiments are described in terms of this example logical circuit 1300. After reading this description, it will become apparent to a person skilled in the relevant art how to implement the technology using other logical circuits or architectures.

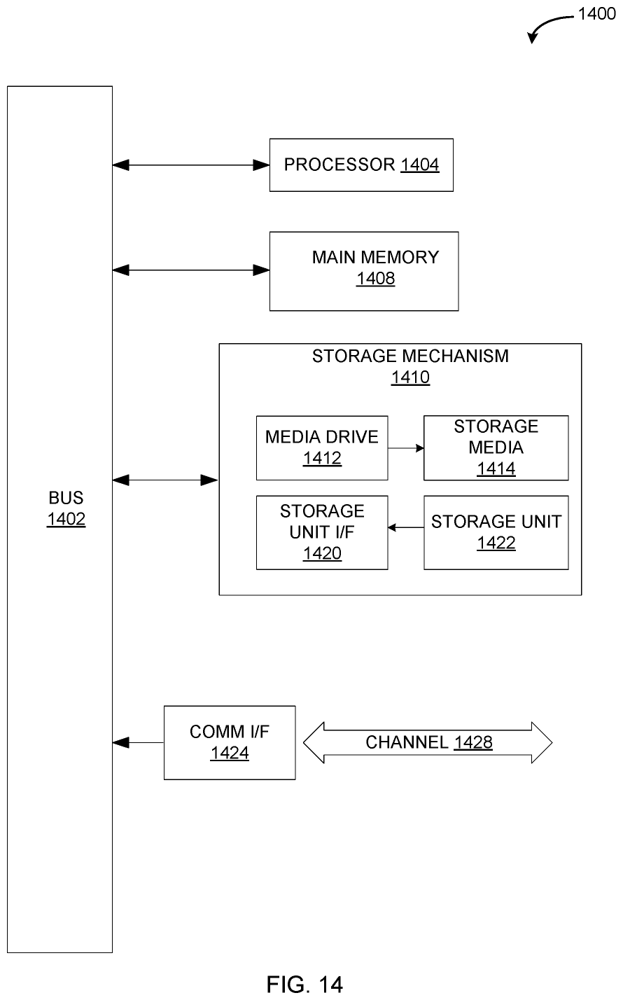

Referring now to FIG. 14, computing system 1400 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 1400 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 1400 might include, for example, one or more processors, controllers, control engines, or other processing devices, such as a processor 1404. Processor 1404 might be implemented using a general-purpose or special-purpose processing engine such as, for example, a microprocessor, controller, or other control logic. In the illustrated example, processor 1404 is connected to a bus 1402, although any communication medium can be used to facilitate interaction with other components of logical circuit 1400 or to communicate externally.

Computing system 1400 might also include one or more memory engines, simply referred to herein as main memory 1408. For example, preferably random-access memory (RAM) or other dynamic memory, might be used for storing information and instructions to be executed by processor 1404. Main memory 1408 might also be used for storing temporary variables or other intermediate information during execution of instructions to be executed by processor 1404. Logical circuit 1400 might likewise include a read only memory (“ROM”) or other static storage device coupled to bus 1402 for storing static information and instructions for processor 1404.

The computing system 1400 might also include one or more various forms of information storage mechanism 1410, which might include, for example, a media drive 1412 and a storage unit interface 1420. The media drive 1412 might include a drive or other mechanism to support fixed or removable storage media 1414. For example, a hard disk drive, a floppy disk drive, a magnetic tape drive, an optical disk drive, a CD or DVD drive (R or RW), or other removable or fixed media drive might be provided. Accordingly, storage media 1414 might include, for example, a hard disk, a floppy disk, magnetic tape, cartridge, optical disk, a CD or DVD, or other fixed or removable medium that is read by, written to, or accessed by media drive 1412. As these examples illustrate, the storage media 1414 can include a computer usable storage medium having stored therein computer software or data.

In alternative embodiments, information storage mechanism 1440 might include other similar instrumentalities for allowing computer programs or other instructions or data to be loaded into logical circuit 1400. Such instrumentalities might include, for example, a fixed or removable storage unit 1422 and an interface 1420. Examples of such storage units 1422 and interfaces 1420 can include a program cartridge and cartridge interface, a removable memory (for example, a flash memory or other removable memory engine) and memory slot, a PCMCIA slot and card, and other fixed or removable storage units 1422 and interfaces 1420 that allow software and data to be transferred from the storage unit 1422 to logical circuit 1400.

Logical circuit 1400 might also include a communications interface 1424. Communications interface 1424 might be used to allow software and data to be transferred between logical circuit 1400 and external devices. Examples of communications interface 1424 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1424 might typically be carried on signals, which can be electronic, electromagnetic (which includes optical) or other signals capable of being exchanged by a given communications interface 1424. These signals might be provided to communications interface 1424 via a channel 1428. This channel 1428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 1408, storage unit 1420, media 1414, and channel 1428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 1300 to perform features or functions of the disclosed technology as discussed herein.

Although FIG. 14 depicts a computer network, it is understood that the disclosure is not limited to operation with a computer network, but rather, the disclosure may be practiced in any suitable electronic device. Accordingly, the computer network depicted in FIG. 14 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method comprising:
receiving a search term from a client device, wherein the search term corresponds with an item type;
transmitting the item type to an advertising exchange computer network associated with a plurality of advertiser user devices;
receiving a plurality of advertisements transmitted from the plurality of advertiser user devices;
correlating the item type with one or more advertisements from the plurality of advertisements;
providing the one or more advertisements to the client device as a set of advertisements; and
receiving a selection of a first advertisement from the set of advertisements, wherein the selection identifies an item identifier associated with the first advertisement that is identified as being acquired as a future purchase in association with the client device.

2. The method of claim 1, wherein the future purchase and funds associated with the one or more advertisements is limited to a predetermined time frame from receiving the selection of the first advertisement.

3. The method of claim 1, further comprising:
receiving a confirmation of the future purchase from the client device within a predetermined time frame from receiving the selection of the first advertisement; and
initiating a credit transfer to a wallet account associated with the client device.

4. The method of claim 3, wherein receiving a confirmation of the future purchase comprises receiving a photograph of a receipt associated with the future purchase from the client device.

5. The method of claim 1, further comprising determining an alert notification associated with the set of advertisements and transmitting the alert notification to the client device.

6. The method of claim 1, wherein the matching procedure comprises routing the item type to an advertising exchange computer network associated with a plurality of advertiser user devices.

7. A computer-implemented method comprising:
generating one or more parameters associated with a user device;
transmitting the one or more parameters to a manufacturing exchange computer network associated with a plurality of manufacturer user devices;
receiving a selection of at least one of the one or more parameters from a plurality of manufacturing user devices within the manufacturing exchange computer network;
associating the plurality of manufacturer devices with the user device;
generating a plurality of offers for the user device based on the manufacturer device; and
simultaneously displaying the plurality of offers on the user device.

8. The method of claim 7, wherein the one or more parameters comprise at least one of age, gender, credit score, past purchases, income level, location, likelihood of purchase, and total expenditures.

9. The method of claim 7, further comprising updating a profile associated with the user device with the extracted data.

10. The method of claim 9, wherein the profile is updated with at least one of demographic information, shipping information and other information provided by a consumer.

11. The method of claim 9, wherein the profile comprises data on recurring purchases. The consumer profile associates with the parameters in order to determine whether a particular consumer is a good match for a particular offer.

12. The method of claim 7, further comprising setting a time limitation for the offer and removing the offer from the user device after expiration of the time limitation.

13. The method of claim 12, wherein setting a time limitation comprises receiving information from a manufacturer device and setting a time limitation based on the information.

14. A non-transitory computer-readable storage medium storing a plurality of instructions executable by one or more processors, wherein the plurality of instructions when executed by the one or more processors cause the processors to:
receive a search term from a client device, wherein the search term corresponds with an item type;
transmit the item type to an advertising exchange computer network associated with a plurality of advertiser user devices;
receive a plurality of advertisements transmitted from the plurality of advertiser user devices;
correlate the item type with one or more advertisements from the plurality of advertisements;
provide the one or more advertisements to the client device as a set of advertisements; and
receive a selection of a first advertisement from the set of advertisements, wherein the selection identifies an item identifier associated with the first advertisement that is identified as being acquired as a future purchase in association with the client device.

15. The non-transitory computer-readable storage medium of claim 14, wherein the future purchase and funds associated with the one or more advertisements is limited to a predetermined time frame from receiving the selection of the first advertisement.

16. The non-transitory computer-readable storage medium of claim 14, wherein the instructions when executed by the one or more processors cause the processors to:
receive a confirmation of the future purchase from the client device within a predetermined time frame from receiving the selection of the first advertisement; and
initiate a credit transfer to a wallet account associated with the client device.

17. The non-transitory computer-readable storage medium of claim 14, wherein the instructions when executed by the one or more processors cause the processors to determine an alert notification associated with the set of advertisements and transmitting the alert notification to the client device.

18. The non-transitory computer-readable storage medium of claim 14, wherein the matching procedure comprises routing the item type to an advertising exchange computer network associated with a plurality of advertiser user devices.

19. A system for facilitating direct communication comprising:
a processor;
a memory; and
a non-transitory computer-readable storage medium storing a plurality of instructions executable by one or more processors, wherein the plurality of instructions when executed by the one or more processors cause the processors to:
transmit the one or more parameters to a manufacturing exchange computer network associated with a plurality of manufacturer user devices;
receive a selection of at least one of the one or more parameters from a plurality of manufacturing user devices within the manufacturing exchange computer network;
associate the plurality of manufacturer devices with the user device through;
generate a plurality of offers for the user device based on the manufacturer device; and
simultaneously display the plurality of offers on the user device.

20. The system of claim 19, wherein the one or more parameters comprise at least one of age, gender, credit score, past purchases, income level, location, likelihood of purchase, and total expenditures.
